(19) United States
(12) Patent Application Publication
(10) Pub. No.: US 2006/0176371 A1
(43) Pub. Date: Aug. 10, 2006

(54) Camcorder and method of recording thereof

(75) Inventors: Lih-Hwa Kuo, Taipei (TW); Chia-Yuan Pang, Taipei (TW); Yi-Chun Sun, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/345,229

(22) Filed: Feb. 2, 2006

(30) Foreign Application Priority Data
Feb. 5, 2005 (TW) 94104124

(51) Int. Cl. H04N 5/225

(52) U.S. Cl. 348/207.1

(57) ABSTRACT

A camcorder includes an interface port, an interface controller and a recorder. The interface port is connected to an external electronic apparatus and transmits data between the external electronic apparatus and the camcorder. The interface controller selects one of the camcorder and the external electronic apparatus to be a host, which outputs a control signal. The recorder records the data to a recording medium according to the control signal.

This application claims the benefit of Taiwan application Serial No. 94104124, filed Feb. 5, 2005, the subject matter of which is incorporated herein by reference.

### BACKGROUND OF THE INVENTION

1. Field of the Invention

The invention relates in general to a camcorder, and more particularly to a camcorder having a recording function.

2. Description of the Related Art

A conventional camcorder has to store data in a magnetic tape, which tends to be damaged due to the mildew caused by the humidity. In order to preserve the data permanently, the data has to be converted and recorded to an optical disk. However, the file converting procedure takes a lot of time and tends to fail, so more and more manufacturers have designed the camcorder with a build-in recorder such as an optical recorder or a hard disk recorder. Thus, the camcorder can record the data of the daily life as well as record the data to an optical disk. Thus, it is an important subject to effectively utilize the advantages of the camcorder with the build-in recorder in the market.

FIG. 1 is a block diagram showing a conventional camcorder and an external host. Referring to FIG. 1, the camcorder 100 includes an interface port and a recorder 120. In this example, the interface port is a USB port 110. When the camcorder 100 is used individually, the captured video data can be transmitted to the recorder 120, which records the captured video data to a recording medium such as an optical disk. When the camcorder 100 is electrically connected to an external host 140 through the USB port 110, the camcorder 100 serves as a USB client, and the external host 140 has to serve as a USB host such as a computer. As this time, the external host 140 regards the camcorder 100 as an external CD (Compact Disk) recorder. The external host 140 controls the camcorder 100 to receive the data of the external host 140, and the recorder 120 records the data to the optical disk.

However, if the camcorder 100 is directly electrically connected to the USB peripheral apparatus serving as the USB client, the camcorder 100 cannot receive the data and directly record the data to the optical disk without the external host 140. That is, the typical camcorder 100, which can only serve as the USB client, only can be controlled by the external host 140. For example, if the user wants to record the data to the camcorder 140 from a USB flash drive serving as the USB client, the data of the USB flash drive has to be read by the external host 140 first and then transmitted to the camcorder 100 by the control of the external host 140 and recorded to the recording medium. Hence, it is very inconvenient for the user.

### SUMMARY OF THE INVENTION

It is therefore an object of the invention to provide a camcorder capable of recording data of a peripheral apparatus to an optical disk directly.

The invention achieves the above-identified object by providing a camcorder capable of recording data of an external electronic apparatus directly. The camcorder includes an interface port, an interface controller and a recorder. The interface port to be externally connected to the external electronic apparatus transmits data between the external electronic apparatus and the camcorder. The interface controller selects one of the camcorder and the external electronic apparatus to be a host, which outputs a control signal. The recorder records the data to a recording medium according to the control signal.

The invention also achieves the above-identified object by providing a method of recording data directly using a recorder in a camcorder which is connected to an external electronic apparatus. The method includes the steps of: selecting the camcorder or the external electronic apparatus to be a host according to the external electronic apparatus; and enabling the host to control the recorder to record the data to a recording medium.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a conventional camcorder and an external host.

FIG. 2 is a block diagram showing a camcorder and an external electronic apparatus according to a preferred embodiment of the invention.

FIG. 3 is a flow chart showing a method of recording data of a camcorder to an external electronic apparatus according to a preferred embodiment of the invention.

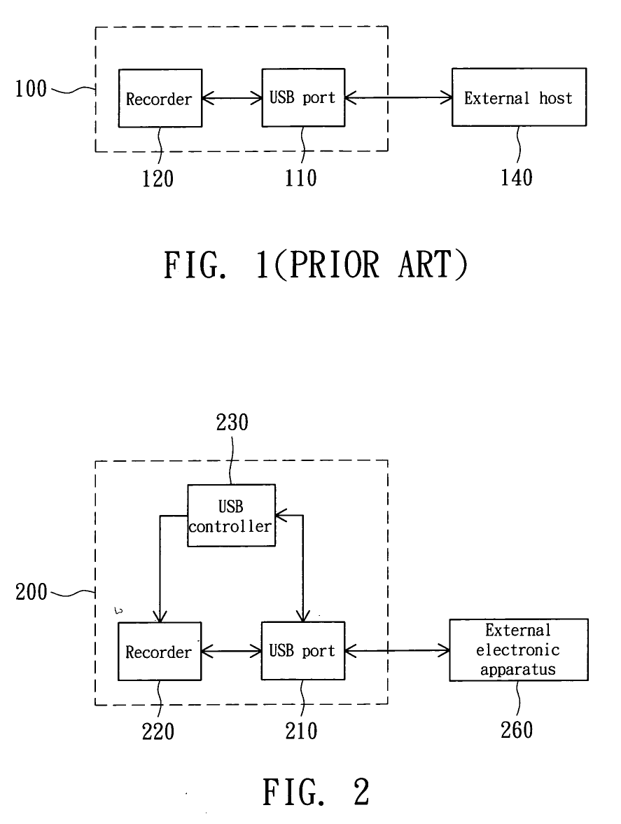

### DETAILED DESCRIPTION OF THE INVENTION

FIG. 2 is a block diagram showing a camcorder and an external electronic apparatus according to a preferred embodiment of the invention. In this embodiment, the external electronic apparatus 260 is a USB (Universal Serial Bus) peripheral apparatus. The camcorder 200 includes an interface port, an interface controller and a recorder 220. In this embodiment, the interface port is a USB port 210 and the interface controller is a USB controller 230. The USB port 210 electrically connected to the external electronic apparatus 260 transmits data between the external electronic apparatus 260 and the camcorder 200. The USB controller 230 selects one of the camcorder 200 and the external electronic apparatus 260 to be a USB host according to the external electronic apparatus 260, and the USB host outputs a control signal. The recorder 220 records the data to a recording medium according to the control signal.

In detail, the USB controller 230 may be, for example, an OTG (On The Go) chip. When the external electronic apparatus 260 may serve as the USB host such as a computer, the USB controller 230 judges the external electronic apparatus 260 as the host and the camcorder 200 as a client. Thus, the external electronic apparatus 260 outputs the control signal and data to the camcorder 200 to control the recorder 220 to record the data to the recording medium, such as a CD (Compact Disk), a DVD (Digital Versatile Disk), or a magnetic disc.

Reversely, when the external electronic apparatus 260 can only serve as the USB client such as the external storage device (USB flash drive), the USB controller 230 regards the camcorder 200 as the host, which outputs the control signal to control the recorder 220 to record the data of the external electronic apparatus 260 to the recording medium. For example, the external storage device is a card reader capable of acquiring data stored in a memory card, such as a SD (Secure Digital) card, a CF (Compact Flash) card or a MMS (Multi Media Card), a MS (Memory Stick) card, a SMC (Smart Media Card) or an XD (EXtreme Digital) picture card.

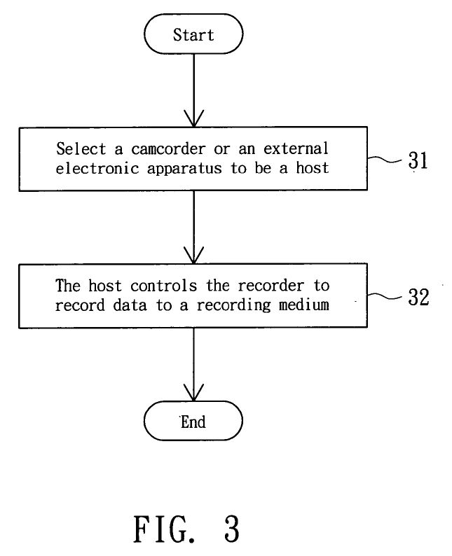

FIG. 3 is a flow chart showing a method of recording data of a camcorder to an external electronic apparatus according to a preferred embodiment of the invention. First, step 31 selects the camcorder 200 or the external electronic apparatus 260 to be the host. Next, step 32 enables the host to control the recorder to record the data to the recording medium.

The camcorder and the recording method thereof according to the embodiment of the invention can directly use the camcorder to record the data in the USB client without the computer for recording the data in the USB client to the recording medium of the camcorder.

In addition, the disclosed but non-restrictive USB interface of this invention may be replaced by other interfaces such as an IEEE 1394 interface.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A camcorder, comprising:
an interface port, which is to be connected to an external electronic apparatus and transmits data between the external electronic apparatus and the camcorder;
an interface controller for selecting one of the camcorder and the external electronic apparatus to be a host, which outputs a control signal; and
a recorder for recording the data to a recording medium according to the control signal.

2. The camcorder according to claim 1, wherein the recorder is an optical recorder or a hard disk recorder.

3. The camcorder according to claim 1, wherein the external electronic apparatus is a USB (Universal Serial Bus) host.

4. The camcorder according to claim 1, wherein the external electronic apparatus is a USB (Universal Serial Bus) peripheral apparatus.

5. The camcorder according to claim 1, wherein the interface controller is a USB OTG (Universal Serial Bus On The Go) chip.

6. The camcorder according to claim 3, wherein the USB host is a computer.

7. The camcorder according to claim 4, wherein the USB peripheral apparatus is an external storage device.

8. The camcorder according to claim 7, wherein the external storage device is a card reader.

9. The camcorder according to claim 8, wherein the card reader comprises a memory card.

10. The camcorder according to claim 9, wherein the memory card is a CF (Compact Flash) card, a SD (Secure Digital) card, a MMC (Multi Media Card), a MS (Memory Stick) card, a SMC (Smart Media Card) or an XD (EXtreme Digital) picture card.

11. The camcorder according to claim 1, wherein the recording medium is an optical disk or a magnetic disk.

12. The camcorder according to claim 11, wherein the optical disk is a CD (Compact Disk) or a DVD (Digital Versatile Disk).

13. A method of recording data using a recorder in a camcorder which is connected to an external electronic apparatus, the method comprising the steps of:
selecting the camcorder or the external electronic apparatus to be a host according to the external electronic apparatus; and
enabling the host to control the recorder to record the data to a recording medium.

14. The method according to claim 13, wherein the recorder is an optical recorder or a hard disk recorder.

15. The method according to claim 13, wherein the external electronic apparatus is a USB (Universal Serial Bus) host.

16. The method according to claim 13, wherein the external electronic apparatus is a USB (Universal Serial Bus) peripheral apparatus.

17. The method according to claim 13, wherein the USB host is a computer.

18. The method according to claim 16, wherein the USB peripheral apparatus is an external storage device.

19. The method according to claim 18, wherein the external storage device is a card reader for reading a memory card, which is a CF (Compact Flash) card, a SD (Secure Digital) card, a MMC (Multi Media Card), a MS (Memory Stick) card, a SMC (Smart Media Card) or an XD (EXtreme Digital) picture card.

20. The method according to claim 13, wherein the recording medium is an optical disk or a magnetic disk.
